(19) United States
(12) Patent Application Publication
(10) Pub. No.: US 2022/0152824 A1
(43) Pub. Date: May 19, 2022

(54) SYSTEM FOR AUTOMATED MANIPULATION OF OBJECTS USING A VISION-BASED COLLISION-FREE MOTION PLAN

(71) Applicant: ARMSTRONG ROBOTICS, INC., New York, NY (US)

(72) Inventors: Axel HANSEN, New York, NY (US); Luke HANSEN, Hanover, NH (US); Jonah VARON, New York, NY (US)

(73) Assignee: ARMSTRONG ROBOTICS, INC., New York, NY (US)

(21) Appl. No.: 17/098,239

(22) Filed: Nov. 13, 2020

(51) Int. Cl. B25J 9/16; B25J 13/08; B25J 19/02; B25J 15/08

(52) U.S. Cl. CPC B25J 9/1666; B25J 9/1676; B25J 15/08; B25J 13/089; B25J 19/023; B25J 9/162

(57) ABSTRACT

In accordance with various aspects and embodiments of the invention, a system and method are provided for manipulation and movement of objects. In accordance with one aspect of the invention, the system includes a robotic arm that grabs and manipulates objects along a collision-free path. The objects can be in a randomly arranged pile or in an orderly arranged location. In accordance with various aspects and embodiments of the invention, the objects are moved from an orderly location to a storage location.

### FIELD OF THE INVENTION

The present invention is in the field of autonomous robotic systems and, more specifically, related to object manipulation and movement using collision-free motion planning for a robotic device.

### BACKGROUND

In a private residence or commercial building objects that assist in eating or cooking, such as dishes, cups, cutlery, silverware, cutting boards, pots, pans, and food trays, are generally used to prepare and consume food, which results in used or dirty objects. Used or dirty objects are collected in the vicinity of a dish cleaning location, such as a dishwasher. At the dish cleaning location, the dirty objects are usually placed into the dishwasher or into dish racks, which are then placed into the dishwasher. This work is very monotonous and very strenuous. Therefore, what is needed is a system and method that, as one objective or task, places the used or dirty objects into the dishwasher or into dish racks that are placed into the dishwasher. Furthermore, what is needed is a system and method that can remove the clean objects from the dishwasher and place them in a storage location until future use. Additionally, there are instances wherein the system and method can, as another objective task, be used to assist with other tasks, such as preparation of food or manipulation of objects to achieve another secondary task.

### SUMMARY OF THE INVENTION

In accordance with various aspects and embodiments of the invention, a system and method are provided for autonomous manipulation and movement of objects. In accordance with one aspect of the invention, the system includes a robotic arm that grasps and manipulates objects and moves objects along a collision-free path. The objects can be in any arrangement, from a randomly arranged pile to an orderly arrangement. In accordance with various aspects and embodiments of the invention, the objects are moved from an orderly location to a storage location.

### BRIEF DESCRIPTION OF THE DRAWINGS

The specification disclosed includes the drawings or figures, wherein like numbers in the figures represent like numbers in the description and the figures are represented as follows:

FIG. 1 shows a process for determining a collision-free motion path to accomplish an objective or goal or task for moving an object in accordance with various aspects and embodiments of the invention.

FIG. 2 shows a block diagram of a robotic system for executing a collision-free motion path to manipulate an object in accordance with various aspects and embodiments of the invention.

FIG. 3 shows a block diagram of a robotic system in an environment according to an embodiment of the present invention.

FIG. 4 shows a block diagram of various fingers for the robot of FIG. 3, which includes an optional second arm, in accordance with various aspects and embodiments of the invention.

FIG. 5 shows a block diagram of a robotic system interacting with the object in accordance with various aspects and embodiments of the invention.

FIG. 6 shows a block diagram of multiple cameras observing the environment of the system of FIG. 2 in accordance with various aspects and embodiments of the invention.

FIG. 7 shows a user interacting with a system in accordance with various aspects and embodiments of the invention.

FIG. 8 shows a server in accordance with various aspects and embodiments of the invention.

FIG. 9 shows a block diagram of a system-on-chip (SoC) in accordance with various aspects and embodiments of the invention.

FIG. 10 shows a rotating disk non-transitory computer readable medium, in accordance with various aspects and embodiments of the invention.

FIG. 11 shows a flash random access memory non-transitory computer in accordance with various aspects and embodiments of the invention.

FIG. 12 shows the bottom side of a computer processor based SoC in accordance with various aspects and embodiments of the invention.

FIG. 13 shows the top side of a computer processor based SoC in accordance with various aspects and embodiments of the invention.

FIG. 14 shows a robotic system or robot in accordance with various aspects and embodiments of the invention.

FIG. 15 shows a mobile robotic system or robot in accordance with various aspects and embodiments of the invention.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment of the invention. Appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein.

All statements herein reciting principles, aspects, and embodiments of the invention are intended to encompass both structural and functional equivalents thereof. It is intended that such equivalents include both currently known equivalents and equivalents developed in the future.

All examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Furthermore, to the extent that the terms “including”, “includes”, “having”, “has”, “with”, or variants thereof are used in either the detailed description and the claims, such terms are intended to be inclusive in a similar manner to the term “comprising.”

The terms configure, configuring, and configuration, as used in this specification and claims, may relate to the assigning of values to parameters, and also may relate to defining the presence or absence of objects. Though this specification offers examples to illustrate various aspects of the invention, many systems and methods that are significantly different from the examples are possible with the invention.

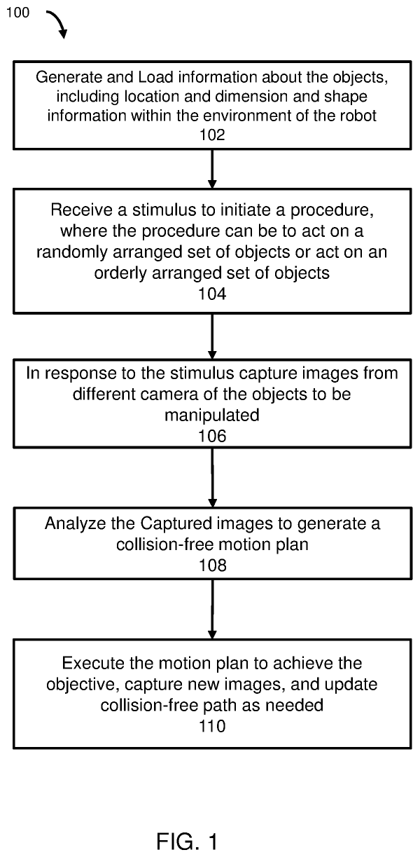

Referring now to FIG. 1, a process 100 is shown for automation of manipulation of an object. As used herein, manipulation includes grabbing, moving, engaging, cutting, stirring, repositioning, placing, etc. In general manipulation or manipulating, as used herein includes handling, managing, or using, especially with skill, in some or as a part of some process of treatment or performance.

In accordance with some aspects and embodiments of the invention, the objects are of known shape and movable, such as dishes or a can of food. In accordance with some aspects and embodiments of the invention, the objects are of known shape and not movable or permanently located, such as countertop.

In accordance with some aspects and embodiments of the invention, the objects are of known shape in a fixed position and movable, such as a cabinet door. In accordance with some aspects and embodiments of the invention, the objects belong to a known category, such as food containers that hold food during cooking, or food items such as an apple, or a cleaning item (such as a sponge).

At step 102 information about each object is generated and loaded into a library or database. For example, in a private residence or a commercial building, there are a defined set of objects in the vicinity or environment of a robotic system. In accordance with the various aspects and embodiments of the invention, the environment of the system is limited because it is based on the system being in a fixed location. In accordance with the various aspects and embodiments of the invention, the environment of the system is a defined area that is accessible by the system being mobile.

In accordance with some aspects of the invention, the environment of the robot is a dynamic environment. There are continuous changes in the environment. For example, the environment changes as objects move or are moved. There are objects in the vicinity of the robotic system. These objects are identified, images of the objects are taken from multiple angles, and the images are loaded into a library or database. This allows the system to have exact information about the shape and size of the object. Other information can be added, such as weight, surface texture, material, etc. Storage location information about the object (or object type) is added to the library. For example, the preferred location of dishes stored on a shelf or the location of forks stored in a drawer. Thus, the system can access the library to determine the storage location for each object, either for retrieving the object from or for replacing the object to the storage location. The information about storage location for each object identified is added to the database along with image information about each object.

At step 104, the system receives a stimulus. The stimulus can be in any form or of any type, including: a photo; a signal sent to the system; a timed-out timer that is either internal to the system; a timed-out signal that is external to the system and sent to the system; a wake-up phrase uttered by a user; a sound in the environment of the system; and movement of the system from a first position to a second position, such as sliding out a drawer that holds the system. In accordance with some aspects of the invention, the stimulus may be a signal from a device in the system's environment that indicates a new task can be executed. For example, if a dishwasher is finished or if an item cooking is ready and can be removed from the cooking device, such as an oven.

Once the system receives the stimulus, the procedure for manipulation of the objects is initiated. In accordance with various aspects and embodiments of the invention, various objectives, goals, or tasks of the system include manipulation of objects. The manipulation can include acting on: dishes randomly placed on a counter or in a sink; dishes orderly stacked in a dishwasher, which needs to be unloaded or emptied; dishes that are located on a shelf that need to be moved to a new location; and assisting in other tasks that are possible in the environment of the system. In accordance with some aspects and embodiments of the invention, the possible tasks include: retrieving items to assist with cooking; using one object to manipulate another object, such as using a knife to cut food; performing actions related to cooking; and other activities in the environment of the system including cleaning of surfaces.

At step 106, the system captures multiple images of the environment of the system. The images are captured by multiple cameras located throughout the environment. In accordance with various aspects and embodiments of the invention, a camera is located on the system and moves when the system moves. As used herein, the cameras can capture still images or video as well as any other image related information.

At step 108, the captured images are provided to the system and analyzed. In accordance with various aspects and embodiments of the invention, the images are provided to a remote computer or server for analysis at a remote location. In accordance with various aspects and embodiments of the invention, the images are provided to an operator at a remote location for visual analysis. The images are analyzed, either by the system, at the remote location, or based on the operator's input. The analysis is performed to determine motion planning for the system. The motion planning is intended to achieve an objective. The motion planning includes determining a collision-free path or collision-free motion plan to manipulate the objects identified in the image. The collision-free path is determined and designed to achieve the objective. The objective can be defined as achieving any task outlined herein. The collision-free motion plan (or path) is planned based on measured risk factors and motion aesthetics in order to optimize the collision-free path for the motion plan. In accordance with one embodiment, a motion plan is to achieve the objective of picking up at least one object in a specific configuration and using the picked object to manipulate a second object in the robot's environment. The second object may be resting on a surface or the second object may be held by a second arm. For example, one objective may be to select a dish and the procedure is washing the dish. In accordance with one embodiment, while one arm holds the dish a second arm washes the dish. The scope of the invention is not limited by the type of task selected or the objective. In accordance with some aspects and embodiments of the invention, the collision-free motion plan alters the robot's environment to enable accomplishing the procedure.

At step 110, the system executes the collision-free path to achieve the objective of the motion planning. As the collision-free path is executed, new or updated images continue to be captured as objects are manipulated. The motion planning is updated, so that new collision-free paths are generated. In accordance with some aspects and embodiments of the invention, the system's control module receives updated images from the cameras (of the object as held by the system) to determine actual object location versus expected object location for any object. The images of actual object location help the system determine updates to the motion plan using real-time information included in the update or real-time images, which may be still images or video. For example, updated images are provided after the arm has grabbed the object. The system's control module analyzes the updated images to identify the actual position of the grabbed object in order to make adjustments in its motion plan to accomplish a safe and aesthetically acceptable way to achieve a goal. For every object that is moved, further new images are captured; the new images are analyzed and new (or updated) motion planning is determined, which results in new or updated collision-free motion paths.

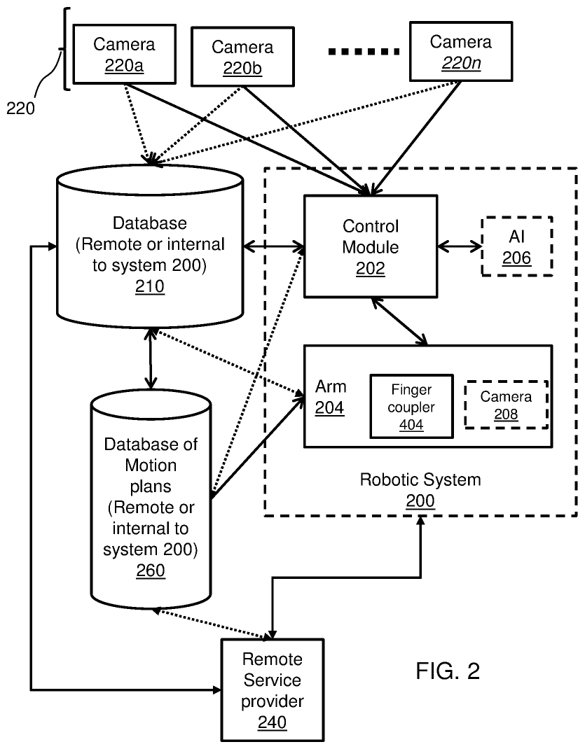

Referring now to FIG. 2, a robotic system 200 is shown. The system 200 includes a control module 202. In accordance with the various aspects and embodiments of the invention, the control module 202 accesses memory or a database for storage and retrieval of information. The memory or database may be included as part of the system 202 or remotely located, as shown. In accordance with some embodiments of the invention, the system 200 also includes an artificial intelligence (AI) module 206. The AI 206 includes neural networks that can be trained to perform recognition of objects in images. The control module 202 identifies the permanent objects in the environment and generates ways to manipulate the permanent objects. The control module 202 identifies the non-permanent objects in the environment and ways to manipulate the non-permanent objects. In accordance with the various aspects and embodiments of the invention, the AI 206 can be trained to perform and performs speech recognition. The AI 206 converts verbal commands to digital information that can be processed by the control module 202 or sent to a remote system or remote location, such as a remote service provider 240.

In accordance with the various aspects of the invention, the provider 240 handles the analysis of the images and determines or generates the motion planning. Images are sent to the provider 240. The provider 240 includes Artificial Intelligence (AI) that analyzes the images to determine object locations and generates the motion planning, which is communicated to the system 200. In accordance with other embodiments of the invention, the system 200 performs the analysis of the images and generates the motion planning. The various embodiments are described herein.

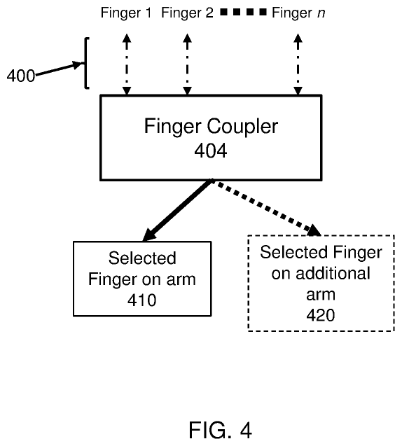

The system 200 includes at least one arm 204. In accordance with the various embodiments of the invention, the system 200 includes at least one additional arm (not shown), which is similar to the arm 204, for use as part of execution of specific procedures or tasks that achieve certain goals. In accordance with the various aspects and embodiments of the invention, the system 200 includes more than two arms, such as the arm 204. As discussed herein and in accordance with one embodiment, the arm 204 includes a coupling mechanism (discussed with respect to FIG. 4, finger coupler 404) for engaging and receiving any finger(s), wherein each finger (or pair of fingers) is designed for specific movements associated with engaging and manipulating an object. The variation in fingers stored in a finger module are of types corresponding to the manner and way in which a type of object needs to be engaged. In accordance with some embodiments of the invention, the arm 204 includes a camera 208. The camera 208 can capture images from the viewpoint of the arm; the images can be either still pictures or video or live streaming.

In accordance with the various embodiments of the invention, the system 200 includes and is in communication with a database 210. In accordance with the various embodiments of the invention, the database 210 is external to the system 200 and in communication therewith. In accordance with the various embodiments of the invention, the system 200 is in communication with a database 260. In accordance with one embodiment of the invention, the database 260 is a designated address range within the database 210. In accordance with the various embodiments of the invention, the system 200 includes a communication module. The system 200 uses the communication module to communicate with a remote system. The remote system sends information to the system 200 that enhances the collision-free path of the motion plan. The remote system can also send information for understanding of the plurality of objects and the robot's environment.

The database 260 is remote from the system 200 in accordance with the various embodiments of the invention. In accordance with the various embodiments of the invention, the database 260 is internal or part of the system 200. The database 260 stores motion plan templates or pre-existing motion plans that can be adapted to create new motion plans. The adapted motion plans can be applied to new object locations and can be loaded and executed by the system 200. The adaptation of existing motion plan templates reduces lag time and increases performance speed. In accordance with the various aspects of the invention, the objective of the motion plan is to empty the dishwasher. Given that the dishwasher was loaded by the system 200, the location of all the objects are known. This can be confirmed and adjusted by capturing images of the objects within the dishwasher after the dish washing cycle is complete. In this way, a motion plan can be generated for unloading the dishwasher and executed by the system 200.

In accordance with the various aspects and embodiments of the invention, the objective of the motion plan is to load dishes from a location into the dishwasher. As noted above, images are captured by cameras 220 of the objects. The cameras 220 are positioned in various locations in the environment of the system 200. In accordance with the various aspects and embodiments of the invention, the cameras 220 send the images to control module 202 of the system 200. The images are stored in the database 210. In accordance with some aspects and embodiments of the invention, information about the camera's position at that time the image is captured is stored. In accordance with some aspects and embodiments of the invention, information about the position of the camera relative to the environment, the robot, and the plurality of objects is stored.

In accordance with the various aspects and embodiments of the invention, the images are sent to the system 200 for analysis. Based on the analysis, the system 200 determines a collision-free path. The system 200 executes the collision-free path. In accordance with the various aspects and embodiments of the invention, the images are sent to a remote service provider 240. The images can be sent from the database 210 to the provider 240. In accordance with the various aspects and embodiments of the invention, the images are sent by the system 200 to the provider 240. The provider 240 analyzes the images and generates a collision-free path to achieve the objective. As new images are captured by the cameras 220, additional analysis is performed to determine if the motion plan needs to be updated and a new collision-free path generated. In accordance with the various aspects and embodiments of the invention, the provider performs the analysis on the new images. In accordance with some aspects and embodiments of the invention, the provider 240 interacts with motion plans stored in the database 260 in order to update or change or utilize one or more of the motion plans. In accordance with some aspects and embodiments of the invention, the control module 202 interacts with motion plans stored in the database 260 in order to update or change or utilize one or more of the motion plans. In accordance with the various aspects and embodiments of the invention, the system 200 performs the analysis on the images.

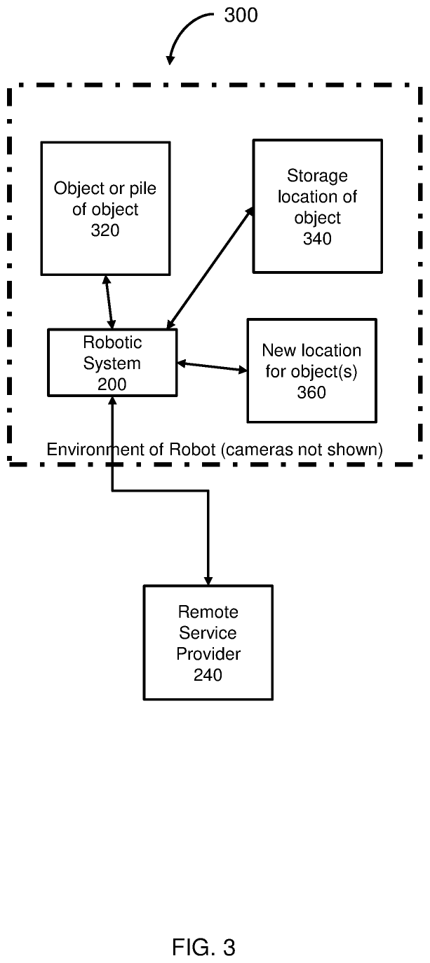

Referring now to FIG. 3, the system 200 of FIG. 2 is shown in an environment 300. The environment 300 includes a location 320 where a pile of randomly placed objects are located. In accordance with the various aspects and embodiments of the invention, the environment 300 includes a location 340 where objects are stored. In accordance with the various aspects and embodiments of the invention, the environment 300 includes a location 360, to where the objects are moved. The system 200 can move objects from any location 320, 340, 360 to a different location. There is no limit to the number of locations that can be selected or defined within the environment 300. In accordance with the various aspects and embodiments of the invention, the environment 300 is a kitchen and location 320 is a sink or a counter, location 340 is the shelf or cabinet where the objects are stored, and location 360 is a dishwasher where the objects are moved to for cleaning.

The system 200 can manipulate the objects within the environment 300 as needed and based on the objective of the motion plan. In accordance with the various aspects and embodiments of the invention, the objective is to load the dishwasher. In accordance with the various aspects and embodiments of the invention, the objective of the motion plan is to retrieve items from the cabinet, for example for assisting with meal preparation. In accordance with the various aspects and embodiments of the invention, the motion plan's objective is to unload a clean dishwasher. In accordance with the various aspects and embodiments of the invention, the motion plan's objective is to clean and wipe down a surface using a sponge. In each instance, the motion plan has an objective and that objective is achieved through a collision-free path plan that is executed by the system 200.

Referring now to FIG. 4, the system 200 accesses a finger module that includes various fingers 400. The system 200 instructs the arm 204 to select fingers based on the objective or task. The arm 204, as shown in FIG. 2, includes the finger coupler 404. The finger coupler 4040 can engage any finger or pair of fingers selected from the fingers 400. In accordance with the various embodiments of the invention, the fingers 400 are located in the environment of the system 200. In accordance with the various embodiments of the invention, the fingers 400 are located on a second arm (not shown) and accessible by the arm 204.

The system 200 has at least one arm. The system selects one or more fingers 410 from the fingers 400 to secure to the arm. In accordance with the various aspects and embodiments of the invention, the system 200 includes a second arm. The second arm can be used to grab and hold an object while the first arm is holding a different object. In this example, the first arm holds a food object and the second arm holds a cutting object. This allows the system to achieve the objective of chopping the food object.

The system selects a second set of fingers 420 for the second arm. Each arm of the system 200 includes a coupling means or mechanism that allows various different fingers 410 to be selected by the system 200 and attached or secured to the arm, and detached or removed from the arm. In accordance with the various aspects and embodiments of the invention, each finger 400 is designed for a specific task that will help the system 200 achieve the objective of the motion plan. The system 200 can move the attached fingers to a desired position with a desired velocity and force, as determined by its motion plan.

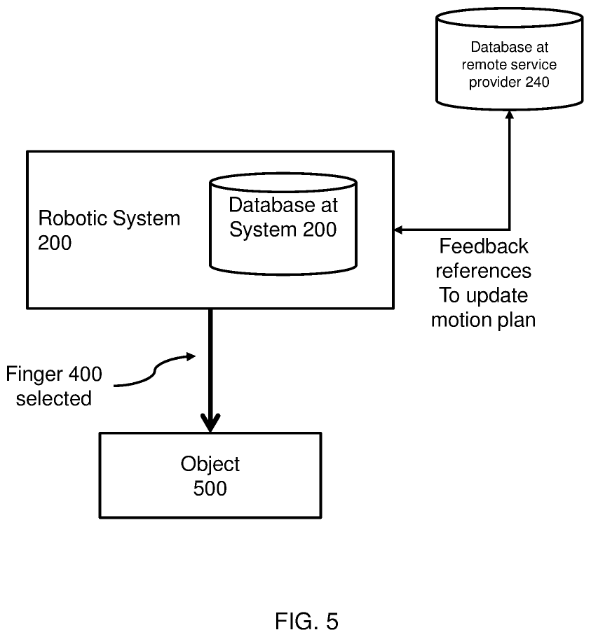

Referring now to FIG. 5, the system 200 selects a finger 400 according to the objective of the motion plan. The system 200 engages an object 500 by grabbing it for manipulation based on execution of the motion plan. Cameras 220 capture images or video footage of the object 500 as held by the finger 400. Cameras 220 also capture images of the objects that are not held by the finger 400 in the environment of the system 200. In accordance with the various aspects and embodiments of the invention, the images or video is stored in any or all databases, which databases are at the system 200 and/or at a remote location. In accordance with the various aspects and embodiments of the invention, the images of the object 500 as held by the finger 400 is analyzed to determine the precise position of the object 500 as it is being held or gripped by the finger 400. If the orientation of the object 500, as grabbed, is not acceptable, then the system 200 can take the necessary action to correct the orientation of the object 500.

In accordance with the various aspects and embodiments of the invention, feedback is provided—such as images or video—to the provider 240 in order to receive an updated motion plan that corrects the orientation of the object 500. For example and in accordance with the various aspects and embodiments of the invention, the updated motion plan causes the system 200 to place the object 500 on a surface and release the object 500 from the finger 400 in a manner that does not damage the object. Then the finger 400 is repositioned relative to the object 500, which is grabbed again. In accordance with the various aspects and embodiments of the invention, the other (additional or second) arm of the system 200 is used to assist in re-positioning the object 500 in the finger 400 of the first arm of the system 200.

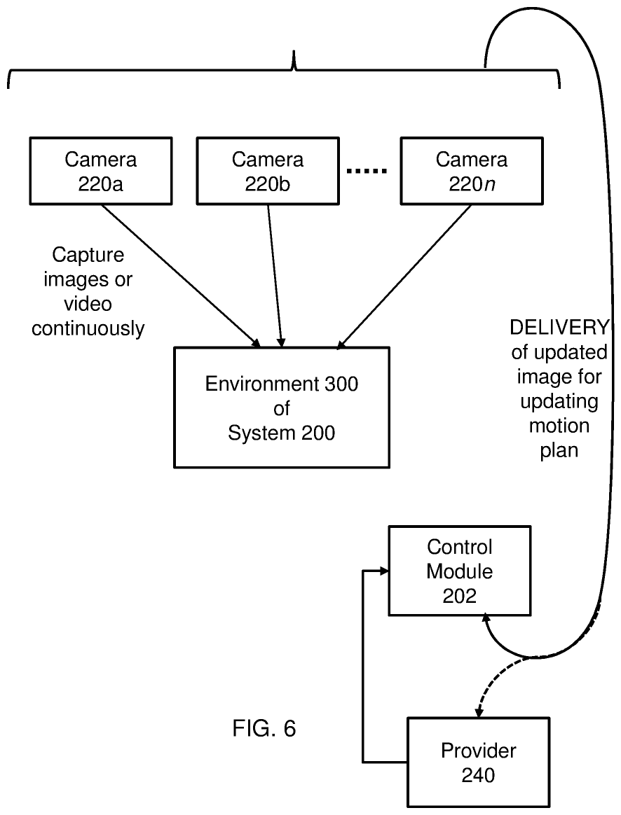

Referring now to FIG. 6, in accordance with the various aspects and embodiments of the invention, the system 200 includes a camera 208 that can capture images or provide video information (continuous information in real time) from the viewpoint of the arm 204 of the system 200. Additionally, in accordance with the various aspects and embodiments of the invention, the environment 300 of the system 200 is monitored by cameras 220a, 220b, . . . 220n that can capture images or provide video information (continuous information in real time) from different angles or viewpoints of the arm of the system 200 in the environment. The image or video is information that is analyzed, in accordance with the various aspects and embodiments of the invention, by the control module 202 of the system 200, in real-time. The real-time updates can be based on the real-time images or video feed that is live and continuous.

In accordance with the various aspects and embodiments of the invention, neural networks are used to analyze the images in real time. The captured images are analyzed using trained neural networks, which use trained machine learning models. The trained machine learning models are trained using real images (seed images) of the objects that are in the environment of the system, or trained using real images of objects similar to the ones in the environment. In accordance with some aspects and embodiments of the invention, the real images are processed to generate or create rasterized images. In accordance with various aspects of the invention, object recognition with an image uses segmentation and relies upon tessellation of an image into superpixels. In accordance with various aspects and embodiments of the invention, the rasterized image includes superpixels, which represent a grouping of pixels that perceptually belong together.

In accordance with the various aspects and embodiments of the invention, the information (images or video—in real-time) is sent to the provider 240 (FIG. 2), or an operator located at the provider 240. The real-time input allows for the provider to send real-time updates for the motion plan to the control module 202 of the system 200.

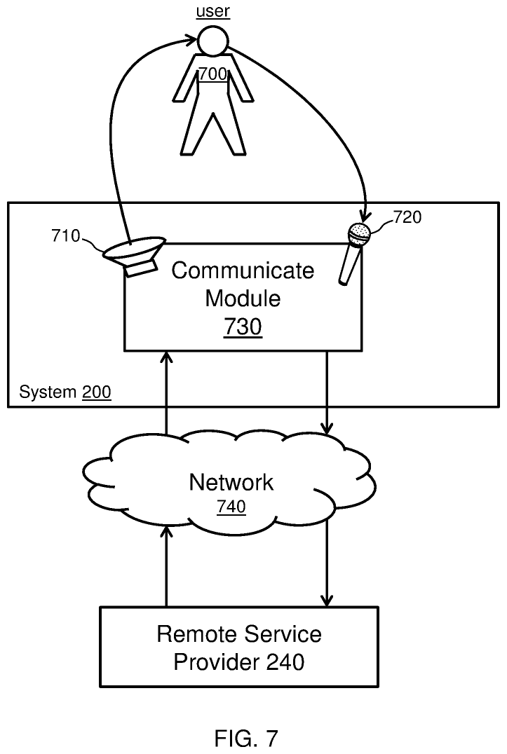

Referring now to FIG. 7, a user 700 communicates with the system 200 through an input module 730. The module 730 receives input from a user and provides the input to the control module 202. The module 730 includes a speaker 710 that delivers audio content to the user 700. The module 730 includes a microphone 720, which receives audio from the user 700. The user 700 can provide instructions to the system 200 in order to initiate execution of a motion plan to achieve an objective, which the user can define. The system 200 or the module 730 communicate, through network 740, with a remote location, such as provider 240.

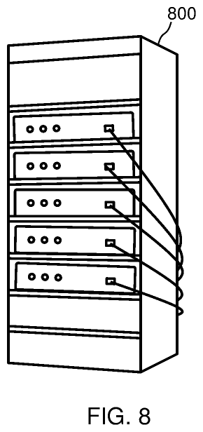

Referring now to FIG. 8, a rack-based server system 800 is shown, as implemented in various embodiments and as a component of various embodiments. Such servers are useful as source servers, publisher servers, and servers for various intermediary functions.

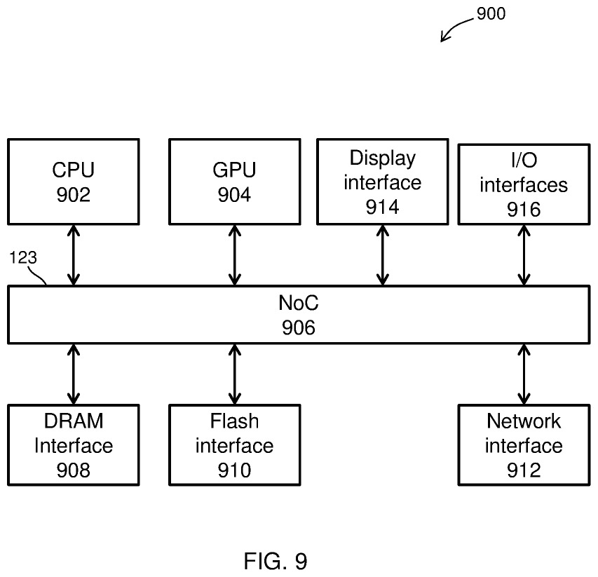

Referring now to FIG. 9, a system-on-chip (SoC) 900 that can be used to implement the system 200 is shown in accordance with the various aspects and embodiments of the invention. The SoC 900 includes a multi-core computer processor (CPU) 902 and a multi-core graphics accelerator processor (GPU) 904. The CPU 902 and GPU 904 are connected through a network-on-chip (NoC) 906 to a DRAM interface 908 and a Flash RAM interface 910. A display interface 914 controls a display, enabling the system to output Motion Picture Experts Group (MPEG) video and Joint Picture Experts Group (JPEG) still image message content. An I/O interface 916 provides for speaker and microphone access for the human-machine interface of a device controlled by the SoC 900. A network interface 912 provides access for the device to communicate with remote provider 240 using servers over the internet.

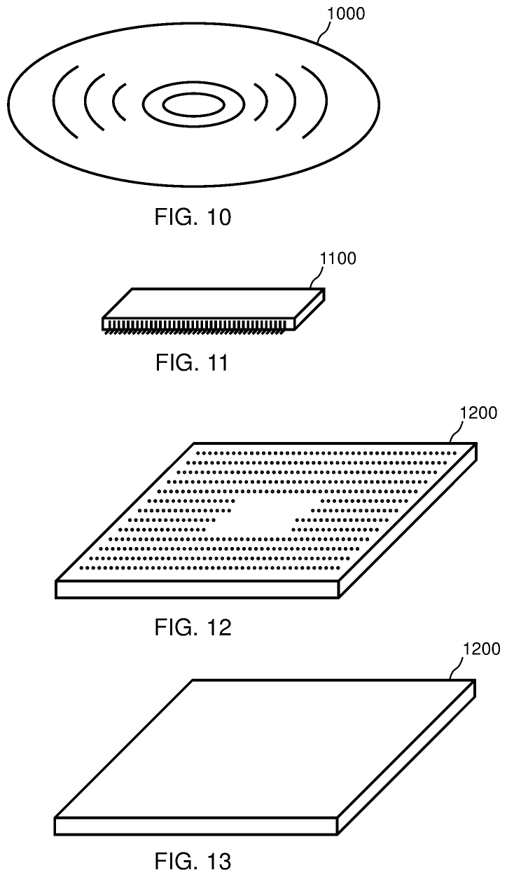

Referring now to FIG. 10, a non-transitory computer readable rotating disk medium 1000 is shown. The medium 1000 stores computer code that, if executed by a computer processor, would cause the computer processor to perform methods or partial method steps described herein in accordance with various aspects of the invention.

Referring now to FIG. 11, a non-transitory computer readable Flash random access memory (RAM) chip medium 1100 is shown. The medium 1100 stores computer code that, if executed by a computer processor, would cause the computer processor to perform methods or partial method steps described herein in accordance with various aspects of the invention.

Referring now to FIG. 12, a bottom side of a packaged system-on-chip (SoC) 1200 is shown. The SoC 1200 includes multiple computer processor cores that have a component of some embodiments and that, by executing computer code, perform methods or partial method steps described herein in accordance with various aspects of the invention.

Referring now to FIG. 13, a top side of the SoC 1200 is shown in accordance with various aspects and embodiments of the invention.

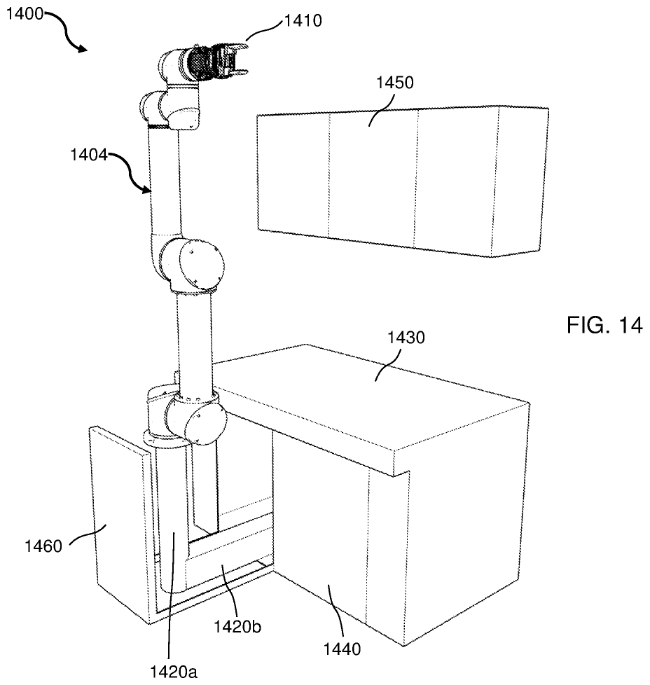

Referring now to FIG. 14, a robotic device 1400 is shown, which can function as the system 200. The device 1400 includes an arm 1404. The device 1400 can include additional arms (not shown). The device 1400 includes a finger module 1410 mounted to the end of the arm 1404, in order to grab and manipulate objects in the environment. The device 1400 includes an adjustable-height stand 1420a, which can raise and lower the device 1400 to increase its reach, and can lower in order to bring the device 1400 underneath the plane of the countertop 1430. The device 1400 includes a sliding base or sliding axis 1420b, which can extend and retract in order to slide the device 1400 underneath the countertop 1430 or to extend the device 1400 away from the countertop 1430. In accordance with the various aspects and embodiments of the invention, the control module plans a motion path that causes storage of the system under a surface (counter) by lowering the one arm (or the arms if there is more than one) by moving the arm(s) to a folded position allowing the system to slide under the surface. In the example of storing the system, the goal would be moving the system's arms to allow for storage, including removal of the fingers from the arm and the collision-free motion plan (generated or retrieved from the database) would achieve this objective.

The device 1400 is mounted near the countertop 1430, a dishwasher 1440, and cabinets 1450. The device 1400 can manipulate objects arranged on the countertop 1430 and place them in dishwasher 1440. The device 1400 can operate dishwasher 1440, causing it to wash the objects. The device 1400 can manipulate objects in dishwasher 1440 and place them into cabinets 1450 or on the countertop 1430. The device 1400 can use other objects such as a sponge (not pictured) to clean the surface of countertop 1430. The device 1400 can arrange itself in a folded position and use adjustable-height stand 1420a and a sliding based or sliding axis 1420b to move itself underneath countertop 1430. A panel 1460 can be attached to sliding axis 1420b, so that when the device 1400 has slid under the countertop 1430, it is hidden from view.

In accordance with some embodiments of the invention, the device 1400 includes a speaker (not shown) on any side or on each side of the device 1400 in order to output audio. The AI 206 (FIG. 2) can receive and process digital information then send it to the speaker for generating an acoustic signal or sound. The device 1400 includes a microphone array (not shown), which includes several microelectromechanical system (MEMS) microphones, physically arranged to receive sound with different amounts of delay. The AI 206 (FIG. 2) can receive and process audio to digital through the microphone. Device 1400 includes an internal processor that runs software that performs digital signal processing (DSP) to use the microphone array to detect the direction of detected speech. The speech detection is performed using various neural networks of the AI 206.

Neural networks are a common algorithm for speech recognition. Neural networks for automatic speech recognition (ASR) must be trained on samples of speech incorporating known words. Speech recognition works best when the training speech is recorded with the same speaker accent and the same background noise as the speech to be recognized. Some ASR system acoustic models are trained with speech over background noise. A navigation personal assistant with the wake-up phrase, “Hey, Nancy.” would appropriately select an acoustic model trained with background noise.

The device 1400 includes a module with one or more cameras to provide images and video (not shown). Further Digital Signal Processing (DSP) software runs neural network-based object recognition on models trained on object forms and human forms in order to detect the location and relative orientation of one or more objects and users. In accordance with various aspects and embodiments of the invention, a module, which is trained using the stored images and the position information for the camera capturing the stored images, confirms an object's position and identity and enhances motion path planning. The device 1400 further includes a display screen (not shown) that, for some experience units, outputs visual message content such as JPEG still images and MPEG video streams.

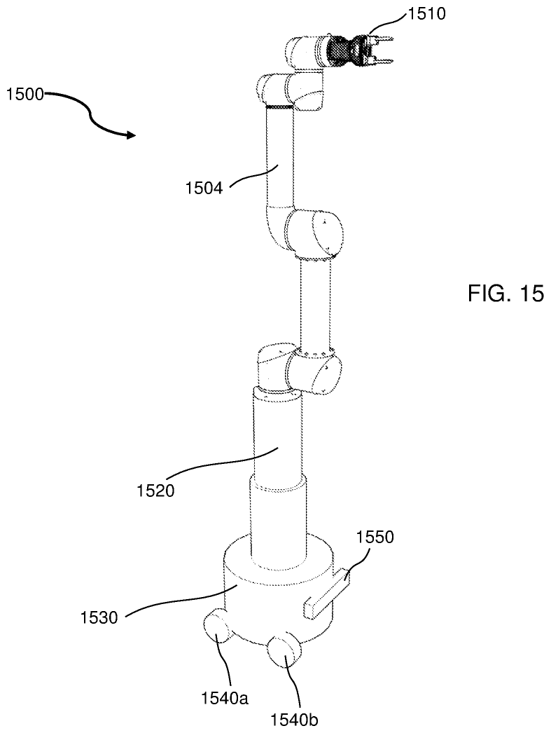

Referring now to FIG. 15, a robotic device 1500 is shown, which can function as the system 200 (FIG. 2) and is similar to the device 1400 (FIG. 14). The device 1500 includes an arm 1504. The device 1400 can include additional arms (not shown). The device 1500 includes a finger module 1510 mounted to the end of the arm 1504, in order to grab and manipulate objects in the environment. The device 1500 includes an adjustable-height stand 1520, which can electronically raise and lower the device 1500 and can lower in order to bring the device 1500 underneath the plane of a surface, such as the countertop 1430 (FIG. 14). The device 1500 includes a mobile base 1530 having a pair of front wheels 1540a and a pair of back wheels 1540b, each of which can turn independently or in unison. The wheels 1540 allow the device 1500 to move about in the environment and can move the device 1500 to a storage location for storing the device 1500 when not in use. For example, the device 1500 can be lowered using the stand 1520 and move underneath the countertop or to extend the device 1500 away from the countertop. In accordance with various aspects and embodiments of the invention, the control module plans a motion path that causes storage of the system under a surface (counter) or in a designated location. The control module can lower the arm(s) and move the arm(s) to a folded position allowing the system to move into the designated space or move under the surface.

Also, the wheels 1504 can turn and, in accordance, the device 1500 is able to move, such as to achieve an objective of a motion plan. By turning independently, the wheels 1540 allow the device 1500 to turn. The device 1500 further includes a camera array 1550, which provides a video stream that can be used to avoid colliding with other objects in the environment. The video stream information is provided to the control module of the device 1500, in accordance with one embodiment of the invention. In accordance with some embodiments of the invention, the video stream information is provided to a remote device (for remote control) that includes a display and controls for moving the device 1500 within the environment, using a remote control. The device 1500 includes a power switch (not shown), which a user can use to activate the device 1500, provide a stimulus that initiates motion planning, or power down the device 1500.

Some embodiments of the invention are cloud-based systems. They are implemented with, and controlled by, a server processor, FPGA, custom ASIC, or other processing device. Such systems also comprise one or more digital storage media such as a hard disk drive, flash drive, solid-state storage device, CD-ROM, floppy disk, or box of punch cards.

Some embodiments access information and data from remote or third party sources. Cloud-based embodiments have network interfaces that interact with network endpoint devices such as mobile phones, automobiles, kiosk terminals, and other voice-enabled devices.

Embodiments of the invention described herein are merely exemplary, and should not be construed as limiting of the scope or spirit of the invention as it could be appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future.

The behavior of either or a combination of humans and machines (instructions that, if executed by one or more computers, would cause the one or more computers to perform methods according to the invention described and claimed and one or more non-transitory computer readable media arranged to store such instructions) embody methods described and claimed herein. Each of more than one non-transitory computer readable medium needed to practice the invention described and claimed herein alone embodies the invention.

Some embodiments of physical machines described and claimed herein are programmable in numerous variables, combinations of which provide essentially an infinite variety of operating behaviors. Some embodiments of hardware description language representations described and claimed herein are configured by software tools that provide numerous parameters, combinations of which provide for essentially an infinite variety of physical machine embodiments of the invention described and claimed. Methods of using such software tools to configure hardware description language representations embody the invention described and claimed. Physical machines, such as semiconductor chips; hardware description language representations of the logical or functional behavior of machines according to the invention described and claimed; and one or more non-transitory computer readable media arranged to store such hardware description language representations all can embody machines described and claimed herein.

In accordance with the teachings of the invention, a system, a computer, and a device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

Article of manufacture (e.g., computer, system, or device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

The scope of the present invention, therefore, is not intended to be limited to the exemplary embodiments shown and described herein. Rather, the scope and spirit of present invention is embodied by the appended claims.

What is claimed is:

1. A robot positioned within an environment monitored by cameras, the robot comprising:
at least one arm for moving or manipulating each of a plurality of objects that are arranged in the robot's environment;
a control module in communication with the at least one arm, wherein the control module:
waits for a stimulus that initiates any one of a plurality of procedures,
receives a plurality of images of the plurality of objects;
analyzes the images to determine a position within the environment for at least a portion of the plurality of objects;
determines goals for at least the portion of the plurality of objects selected from the plurality of objects to manipulate, and determines how to manipulate the objects selected from a plurality of objects based on analysis of the plurality of images, and initiates a procedure selected from the plurality of procedures that supports achieving the goals;
identifies an order of accessing the portion of the plurality of objects to accomplish the goals; and
generates a collision-free motion plan for the at least one arm to accomplish the goals, wherein the collision-free motion plan is a safe and aesthetically acceptable way to achieve the goals using the procedure.

2. The robot of claim 1, wherein the control module is provided with information about the robot's location in the robot's environment, configuration of permanent objects in the robot's environment, and non-permanent objects the robot should identify in the images of the robot's environment.

3. The robot of claim 1, wherein the collision-free motion plan includes safely picking up all of the plurality of objects from one part of the robot's environment and placing the plurality of objects in an organized manner in a target location.

4. The robot of claim 1, wherein the plurality of objects are dishes and the target location is a dishwasher and the procedure is placing each of the plurality of objects in the dishwasher to achieve the objective of loading the dishware.

5. The robot of claim 1, wherein the plurality of objects are dishes in a dishwasher and the target location are various shelves and drawers in the robot's environment and the procedure is removing the plurality of objects from the dishwasher to place the plurality of objects in a desired location on any of the shelves or drawers to achieve the objective of emptying the dishwasher.

6. The robot of claim 1 further comprising a second arm, wherein the collision-free motion plan includes safely picking up an object selected from the plurality of objects in a specific configuration in any one arm including the at least one arm and the second arm, and generating an updated collision-free motion plan for another arm to manipulate the object selected from the plurality of objects.

7. The robot of claim 6, wherein the selected object belongs to a food category and the procedure is using another object to engage the selected object while one of the at least one arm or the second arm holds the selected object and the other arm uses the another object to engage the selected object.

8. The robot of claim 6, wherein the selected object is a dish and the procedure is washing the dish while one of the at least one arm or the second arm holds the dish and the other arm washes the dish.

9. The robot of claim 1, wherein a procedure includes a motion plan for picking up at least one object selected from the plurality of objects in a specific configuration and using the picked object to manipulate a second object in the robot's environment.

10. The robot of claim 9, wherein the picked object is a cooking utensil and the procedure is a cooking task to prepare a meal as a goal.

11. The robot of claim 1, wherein the control module receives updated images to determine actual object location versus expected object location for any object in order to determine real time information.

12. The robot of claim 11, wherein the updated images are provided after the at least one arm has grabbed the object selected from the plurality of objects and the control module analyzes the images to identify position of the grabbed object in order to make adjustments in its motion plan to accomplish safe and aesthetically acceptable way to achieve a goal.

13. The robot of claim 1 further comprising:
a sliding base; and
an adjustable-height stand,
wherein the sliding base and adjustable-height stand are secured to the at least one arm in order to autonomously store and deploy the robot,
wherein the at least one arm is deployed by the control module after receiving the stimulus so that the at least one arm is used by sliding out and raising the adjustable-height stand.

14. The robot of claim 1 further comprising:
a moving base; and
an adjustable-height stand secured to the moving base,
wherein the at least one arm is mounted to the adjustable-height stand and the control module can direct the moving base and the adjustable-height stand to move around the robot's environment and direct the moving base and the adjustable-height stand to store the robot.

15. The robot of claim 1, wherein the control module generates additional collision-free motion plans by adapting pre-existing motion plans to specific positions of the plurality of objects and evaluating safety and likelihood of success for the specific positions.

16. The robot of claim 1, wherein the stimulus is at least selected from the group including: a signal from another system, a signal from a timer, and a command from a user.

17. The robot of claim 1 further comprising a camera mounted to the at least one arm for capturing image information from the robot's point-of-view.

18. A robot comprising:
at least one arm including a finger coupler;
a finger module including a plurality of fingers, wherein the fingers can be secured to the at least one arm's finger coupler and the fingers are selected for the necessary manipulation action needed for a specific object in the robot's environment;
a control module in communication with the at least one arm, wherein the control module:
determines which fingers to use to successfully accomplish a task in a dynamic environment; and
directs the robot to attach specific fingers to best accomplish a task in a dynamic environment.

19. A robot positioned within an environment, the robot comprising:
a sliding base with an adjustable-height stand;
at least one arm, wherein the at least one arm is secured to the adjustable-height stand to allow the at least one arm to be moved in the environment; and
a control module in communication with the at least one arm, wherein the control module can direct the sliding base, the adjustable-height stand and the at least one arm to retract the robot to a storage position and extend the robot to a position where it can reach the environment.

20. The robot of claim 19, wherein the control module can direct the sliding base and the adjustable-height stand to raise or lower the at least one arm to enable the at least one arm to better access part of the environment.
